(19) United States
(12) Patent Application Publication
(10) Pub. No.: US 2025/0251900 A1
(43) Pub. Date: Aug. 7, 2025

(54) OFFLOADING A CPU-BASED AUDIO PUMP AND PROCESSING TO AN AUDIO CO-PROCESSOR

(71) Applicant: Microsoft Technology Licensing, LLC, Redmond, WA (US)

(72) Inventor: Kishore A. KOTTERI, Sammamish, WA (US)

(73) Assignee: Microsoft Technology Licensing, LLC, Redmond, WA (US)

(21) Appl. No.: 18/433,267

(22) Filed: Feb. 5, 2024

(51) Int. Cl. G06F 3/16

(52) U.S. Cl. CPC G06F 3/162

(57) ABSTRACT

Techniques are described for offloading an audio pump from a central processing unit (CPU) of a computing device to an audio co-processor. A device graph for an audio endpoint can be modified to include a processing pipeline for an audio stream from an application. Audio data from the audio stream can be retrieved by the audio co-processor from a shared buffer accessible to the application and the audio co-processor. The processing pipeline for the audio stream can include a series of audio processing objects (APOs) linked by connection buffers. Audio data from the audio stream can be processed by executing an audio pump thread with the audio co-processor. Multiple audio streams can be executed in parallel by the audio pump thread, including render, capture, and loopback streams, with better glitch resilience, relatively low latency, and a better power profile.

### BACKGROUND

Applications executing in an operating system of a computing device may have shared access to audio peripheral devices such as speakers and microphone. To ensure that multiple applications can concurrently use the audio peripheral devices, some operating systems implement an “audio device graph” for each audio peripheral device. For an audio output peripheral device such as speakers, the associated audio device graph can mix audio data from multiple applications before sending the final mix to the speakers. For an audio input peripheral device such as a microphone, the associated audio device graph can split audio from the microphone in order to provide microphone data to multiple applications.

Additionally, audio device graphs can provide a central location for implementing audio effects such as volume control and audio metering, as well as optional audio enhancements such as equalizer, echo canceler, and other original equipment manufacturer (OEM) effects for a given audio peripheral device, without having to change or update the applications that are rendering and/or capturing audio.

In some operating systems, audio device graphs are executed on a pump thread that runs periodically at a fixed cadence to perform the mixing and splitting of audio. The cadence of the audio pump determines the latency and power characteristics of the audio stack: a smaller cadence results in lower latency but higher power consumption, and vice versa.

### SUMMARY

Past approaches attempting to address the problem of minimizing both latency and power consumption include using a pump cadence that provides an acceptable tradeoff for the platform in some usage scenarios. However, when concurrent render, capture, and loopback streams are used, such as in communications scenarios, three independent pump threads running at a given pump cadence can potentially keep the CPU running all the time.

One past approach for minimizing latency and power consumption without monopolizing CPU resources is the “big buffer offload” approach. This “big buffer offload” solution utilizes an audio co-processor such as a digital signal processor (DSP) for render endpoints (e.g., audio playback devices such as speakers and headsets). The audio co-processor can receive a limited number of “big buffer” audio streams which are then mixed with a system pin that runs at a given pump cadence.

However, because the “big buffer offload” approach essentially places the operating system's CPU-based mixer in series with the mixer implemented in the audio co-processor, this approach suffers from several drawbacks. As one example, the series arrangement of the mixers increases latency for audio streams rendering to the system pin. As another example, this approach has the disadvantage of requiring duplication of audio processing algorithms in both the CPU and the audio co-processor.

Further, because the mixer in the audio co-processor is often owned by the OEM of the audio co-processor and “baked in” to the audio co-processor hardware, the computing device (e.g., the CPU) may be unable to add to or change the topology of any audio device graphs on the audio co-processor. Accordingly, in this approach, the audio device graphs on the audio co-processor are static and the computing device is unable to dynamically modify the audio device graphs to accommodate desired scenarios (e.g., to add new effects or otherwise change the graph topology).

Still further, the “big buffer offload” approach cannot be applied to scenarios involving both capture and render, or scenarios involving simultaneous capture, render, and loopback. Accordingly, a solution for audio processing is needed which can support such scenarios, which are increasingly common.

In summary, the detailed description presents innovations in offloading an audio pump to an audio co-processor. The innovations described herein enable scenarios requiring processing of multiple audio streams without burdening the CPU by performing the audio processing on the audio co-processor. Accordingly, the innovations described herein improve the experience of a user of client computing device by minimizing latency and power usage while improving glitch resilience.

The innovations described herein can be implemented as part of a method, as part of a computer system (physical or virtual, as described below) configured to perform the method, or as part of a tangible computer-readable media storing computer-executable instructions for causing one or more processors, when programmed thereby, to perform the method. The various innovations can be used in combination or separately. The innovations described herein include the innovations covered by the claims. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the invention will become more apparent from the following detailed description, which proceeds with reference to the accompanying figures and illustrates a number of examples. Examples may also be capable of other and different applications, and some details may be modified in various respects all without departing from the spirit and scope of the disclosed innovations.

### BRIEF DESCRIPTION OF THE DRAWINGS

FIG. 1 is a diagram of an example processing flow for multiple audio streams in which an audio pump has been offloaded from a CPU to an audio co-processor.

FIG. 2 is a diagram of an example audio device graph builder for a render scenario.

FIG. 3 is a diagram of an example audio device graph builder for a render and capture scenario.

FIG. 4 is a diagram of an example audio device graph builder for a render and loopback scenario.

FIG. 5 is a flowchart illustrating an example technique for executing an audio pump.

FIG. 6 is a diagram of an audio co-processor processing audio streams at an example pump cadence of 5 ms.

FIG. 7 is a diagram of an example audio stack.

FIG. 8 depicts flowcharts illustrating an example technique for configuring and implementing an audio device graph for an audio stream.

FIG. 9 is a flowchart illustrating an example technique for executing an audio pump thread on an audio co-processor to process an audio stream.

FIG. 10 is a diagram of an example computing system in which some described embodiments can be implemented.

### DETAILED DESCRIPTION

The detailed description presents innovations in offloading a CPU-based audio pump to an audio co-processor. The innovations can enable processing of audio streams with relatively low latency and power usage, even in scenarios where multiple audio streams are processed in parallel (e.g., communications scenarios with concurrent render, capture, and loopback streams).

The disclosed innovations include modifying a device graph for an audio endpoint to include a processing pipeline for an audio stream from an application. Audio data from the audio stream can be retrieved by the audio co-processor from a shared buffer accessible to the application and the audio co-processor. The processing pipeline for the audio stream can include one or more audio processing objects (APOs) linked by connection buffers. Each APO can include a configuration interface accessible to the CPU and a streaming interface accessible to the audio co-processor. Audio data from the audio stream can be processed via the processing pipeline by executing an audio pump thread with the audio co-processor. Multiple audio streams can be processed in parallel via respective processing pipelines by executing the audio pump thread, including render, capture, and loopback streams.

In the examples described herein, identical reference numbers in different figures indicate an identical component, module, or operation. Depending on context, a given component or module may accept a different type of information as input and/or produce a different type of information as output.

More generally, various alternatives to the examples described herein are possible. For example, any of the methods described herein can be altered by changing the ordering of the method acts described, by splitting, repeating, or omitting certain method acts, etc. The various aspects of the disclosed technology can be used in combination or separately. Different embodiments use one or more of the described innovations. Some of the innovations described herein address one or more of the problems noted in the background. Typically, a given technique or tool does not solve all such problems.

### I. Example Audio Processing Flows

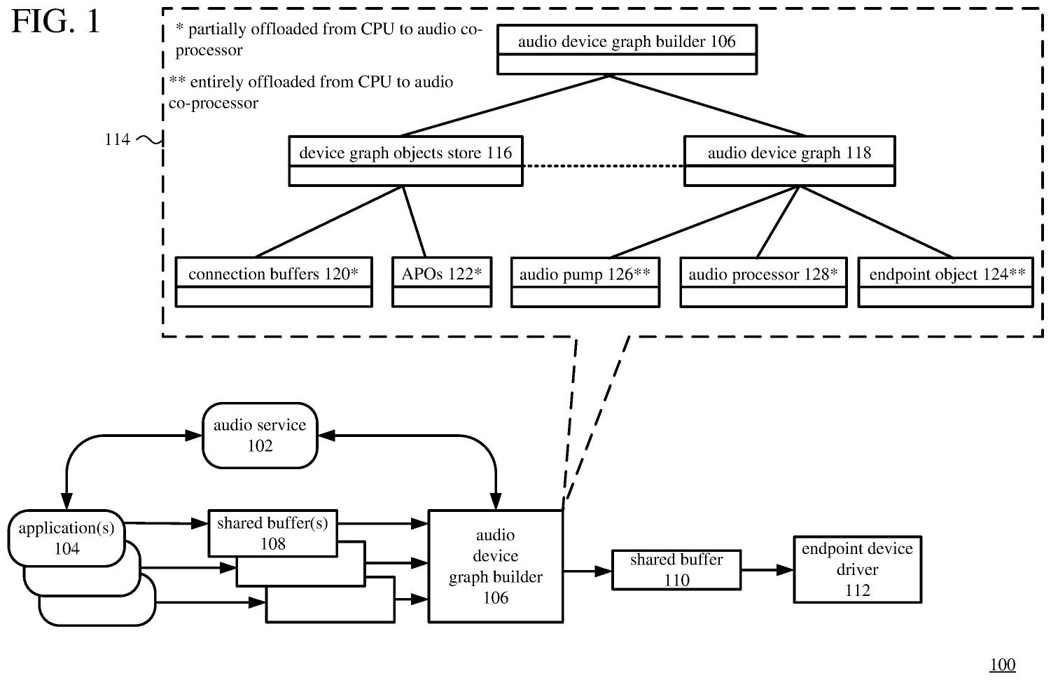

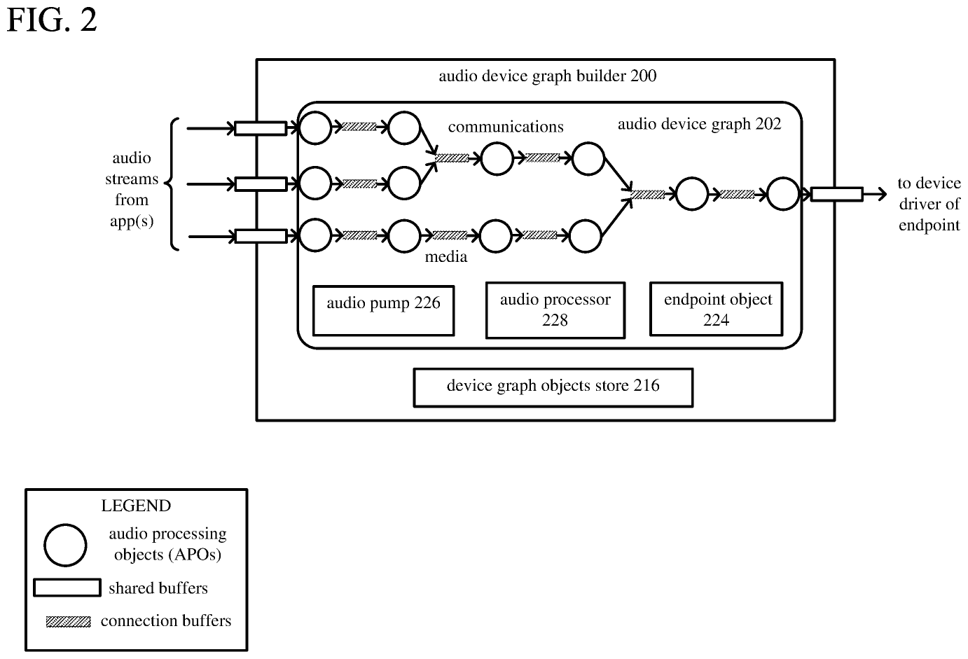

FIG. 1 shows an example audio processing flow (100) that can be implemented in an audio stack of a computing device. Audio processing flow (100) includes an audio service (102). The audio service (102) is responsible for audio stream creation and management on the computing device. Towards this end, audio service (102) communicates with application(s) (104) executing on the computing device via one or more application programming interfaces (APIs). For example, each application (104) can initiate an audio stream creation request with audio service (102) via an API. As discussed further below with reference to FIG. 2, audio service (102) can be a user mode service within the audio stack of the computing device.

Upon receipt of the request, audio service (102) can request that a new audio stream be added to an audio device graph builder (106), alternatively referred to herein as builder (106) for the sake of brevity. Builder (106) is a child process spawned by the audio service (102) which reacts to commands received from the audio service (102) to create, destroy, start, or stop audio streams to or from application(s) (104). In particular, builder (106) receives audio streams from applications, performs processing on the audio streams, and then pushes the resulting processed audio stream(s) to endpoints (or vice versa in the case of audio capture). Towards this end, builder (106) enacts an audio mixer for audio data streaming to or from applications. For example, builder (106) handles buffer transfers of audio data streaming to or from application(s) (104) as well as processing of audio data transmitted to or from application(s) (104). As used herein, the term “audio stream” refers to any flow or time series of digitized audio content.

In response to the request to add the new audio stream, builder (106) creates an application-side shared buffer (108). Shared buffer (108), which can alternatively be referred to as an application-side cross-process buffer or simply a cross-process buffer, is a memory buffer shared between the builder (106) and the application (104) that initiated the audio stream creation request. In render scenarios, the application (104) can write its audio data to shared buffer (108), after which the builder (106) can read the audio data from shared buffer (108). In capture scenarios, the application (104) can read captured audio data from shared buffer (108) after it has been processed in the manner described below.

In a render scenario, after creation of the shared buffer (108), the application (104) writes an audio stream to the shared buffer (108), and the builder (106) reads the audio stream from shared buffer (108) and processes the audio stream. After processing the audio stream, the builder (106) writes the audio stream to an endpoint-side shared buffer (110) which is a memory buffer shared between the builder (106) and a device driver (112) of an endpoint. Shared buffer (110) can alternatively be referred to as an endpoint-side cross-process buffer or simply a cross-process buffer. The endpoint can be an audio peripheral device capable of rendering audio data such as speakers or a headset, or another device configured to render audio data.

In a capture scenario, after creation of the shared buffer (108), an audio stream is captured via the endpoint (e.g., a microphone or another device configured to capture audio data) and written to shared buffer (110). The builder (106) then reads the captured audio stream from shared buffer (110) and processes the audio stream. After processing the audio stream, the builder (106) writes the audio stream to the application-side shared buffer (108), from which the audio stream can be read by the application.

### A. Audio Device Graph Builder.

As shown in callout (114), builder (106) hosts a device graph objects store (116) and an audio device graph (118). Device graph objects store (116), alternatively referred to herein as objects store (116) for the sake of brevity, is a collection of objects that are used by an audio device graph for an endpoint. The objects can include connection buffers (120) and APOs (122). As described further below, the connection buffers (120) and the APOs (122) have been partially offloaded from the CPU of the computing device to the While callout (114) shows a single objects store (116) and a single audio device graph (118) for the sake of brevity, builder (106) can include an objects store (116) and one or more audio device graphs (118) for each endpoint, as discussed further herein.

APOs (122) are objects which act upon audio buffers and transform the audio data in some manner. One or more of APOs (122) can be functional blocks of code provided by an operating system of the computing device. Some examples of APOs include APOs that perform functions such as format conversion (e.g., conversion of floating-point data to integer data), volume control, metering, channel matrixing, sample rate conversion, constriction, echo cancellation, noise suppression, deep noise suppression, spatialization, room correction, loudness equalization. OEM APOs can include custom processing provided by independent software vendors (ISVs) and thus can be tuned to hardware. Example OEM APOs include APOs that perform speaker compensation and/or correction.

Other example APOs (122) include 1-in, 1-out APOs, such as APOs that receive and output an audio stream in Pulse Code Modulation (PCM) format and APOs that receive an audio streams in PCM format and output the audio stream in a compressed format; 1-in, 2-out APOs that perform spatial stream processing; and N-in, 1-out APOs such as Acoustic Echo Cancellation (AEC) APOs and adaptive spatial renderer APOs.

Connection buffers (120) are memory buffers (e.g., units of tangible memory) used to temporarily hold audio data that is presented to the input and output of an APO (122). Each connection buffer (120) can serve as the input to one or more other APOs (122). The computing device can include multiple audio pins, and a memory buffer (e.g., an endpoint-side shared buffer) at each audio pin can be connected to a device graph for an audio endpoint comprising a series of chained APOs linked together by connection buffers, as well as to a device driver of the audio endpoint. The series of chained APOs linked together by connection buffers can also be referred to as a processing pipeline. One or more audio render streams transmitted from applications can be processed via the device graph and then output to the audio peripheral device. Conversely, audio capture streams can be received from an audio endpoint, processed via a device graph for the audio endpoint comprising a series of chained APOs linked together by connection buffers, and then transmitted to an application-side shared buffer for retrieval by an application.

For example, in a render scenario, a processing pipeline (e.g., a series of chained APOs) can process audio data from an input buffer (e.g., an application-side shared buffer accessible to an application that originated the audio stream as well as to the audio co-processor hosting the audio device graph) and fill an output buffer (e.g., an endpoint-side shared buffer accessible to the audio co-processor as well as to a device driver of an audio render endpoint associated with the audio device graph) with the processed audio data. Similarly, in a capture scenario, a series of chained APOs can process audio data from an input buffer (e.g., an endpoint-side shared buffer accessible to the audio co-processor as well as to a device driver of an audio capture endpoint associated with the audio device graph) and fill an output buffer (e.g., an application-side shared buffer accessible to an application that will receive the captured audio stream as well as to the audio co-processor hosting the audio device graph) with the processed audio data.

While a single objects store (116) is depicted in FIG. 1, it will be appreciated that builder (106) can maintain an independent objects store (116) for each endpoint in some examples. In such examples, the device graph for an endpoint cannot access the APOs (122) or connection buffers (120) that exist in the objects store for another endpoint, and vice versa. As such, in such examples, audio data cannot move across device graphs through the connection buffers of the objects store; rather, other objects are used to facilitate this.

As shown, objects store (116) is communicatively coupled with the audio device graph (118). Audio device graph (118) is an object that represents the device graph on a single pin instance (e.g., the device graph for a pin that connects to an audio device). Each audio device graph (118) can be initialized with a reference to the objects store (116) for the endpoint that the audio device graph (118) is created on. This allows the audio device graph (118) on an endpoint to access all the APOs and connection buffers initialized for that endpoint.

A given endpoint can be associated with multiple audio device graphs (118), each of which have access to the common pool of APOs (122) and connection buffers (120) in the objects store (116) for that endpoint. This allows for scenarios in which, for example, APOs and/or connection buffers assigned to a default media mode audio device graph are reassigned to a communications mode audio device graph.

The lifetime of an audio device graph (118) for a given endpoint is not related to the lifetime of the objects store (116) of that endpoint, or of the APOs (122) and connection buffers (120) therein. This makes it possible for an audio device graph (118) for an endpoint to be replaced with another audio device graph (118), perhaps with different initialization parameters, which then re-uses the APOs (122) and connection buffers (120) from the objects store (116) associated with the endpoint. Such operation can be appropriate when an audio device graph (118) transitions to low latency mode and back, or when a match format stream is engaged.

To implement mixing functionality, audio device graph (118) can include references to a plurality of objects to implement mixing functionality. These objects can include an endpoint object (124), an audio pump (126), and an audio processor (128). Endpoint object (124) is an object that represents the pin instance on which the graph is being constructed. Endpoint object (124) provides abstractions for buffer completion events and an endpoint buffer and endpoint clock. Buffer completion events determine the cadence for audio pump (126), whereas the endpoint buffer is a pointer to the audio buffer to which the output of the audio pump (126) is written (e.g., an endpoint-side shared buffer (110) in a render scenario).

Audio pump (126) is an object that encapsulates the thread that runs the mixing pass. As used herein, the term “thread” refers to a unit of execution within a process. This object wakes up on a trigger, such as a buffer completion signal from a device driver of an endpoint (e.g., an audio peripheral device) or a timer. The audio pump (126) then initiates a “processing pass” in which it processes the APOs (122) of the audio device graph (118) for the endpoint in order (e.g., in the sequence dictated by the audio device graph). After processing the APOs (122) in the specified order, the thread awaits another trigger.

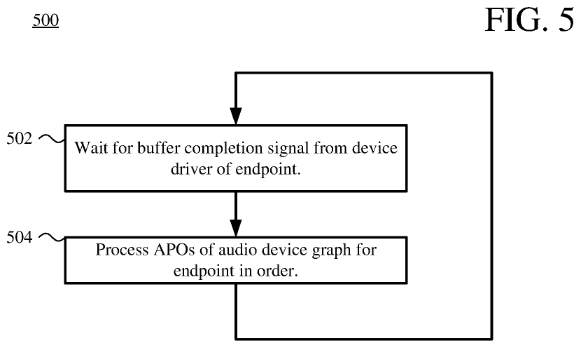

Audio pump (126) can also encapsulate functionality for ensuring that the mixing thread runs at the appropriate priority level to be resilient to glitches. An example audio pump thread is described further below with reference to FIG. 5.

The audio processor (128) object includes the list of APOs (122) and connection buffers (120) to be processed at every pump pass of the audio pump (126). Further, the audio processor (128) object holds the actual mixing logic and ensures that the APOs (122) are invoked in the correct order to execute a pump pass. The audio processor (128) object relies on the audio pump (126) object to “kick-off” (e.g., initiate) the pump pass. Once a pump pass is completed, control is returned to the audio pump (126), which then performs post-pass tasks before waiting once again for the trigger for the next pump pass. Cr

Because the audio processor (128) is where the pump pass is executed, the audio processor (128) includes references to the APOs (122) and connection buffers (120) stored in the objects store (116). The same is not true of the audio pump (126), which is not itself concerned with APOs (122) or connection buffers (120).

B. Example Techniques for Offloading an Audio Pump from a CPU to an Audio Co-Processor.

As indicated in callout (114), some of the objects that form builder (106) have been partially offloaded from a CPU of the computing device to an audio co-processor, while other objects that form builder (106) have been entirely offloaded from the CPU of the computing device to an audio co-processor. Offloading of an object indicates the degree to which processing to implement functionality of the object is delegated from a CPU to an audio co-processor, which can reflect an engineering decision at design time or can reflect a run-time decision about allocation of resources. While offloading of objects (e.g., blocks of code or processing instructions) from the CPU to the audio co-processor is discussed herein, other portions of builder (106) can also be offloaded, such as non-object components of builder (106).

The audio co-processor to which the objects are offloaded can be a DSP, or another device capable of performing the functionality of the offloaded portions described below. An object of builder (106) described as having been partially offloaded from the CPU to the audio co-processor can include one or more interfaces and/or buffers accessible to the CPU as well as one or more interfaces accessible to the audio co-processor. In contrast, an object of builder (106) described as having been entirely offloaded from the CPU of the computing device to the audio co-processor does not include any interfaces configured to be accessed by the CPU; rather, all processing associated with that object is performed by the When an object is offloaded to the audio co-processor, the audio co-processor has created an audio device graph that includes an instance of the object, and the instance of the object executes on the audio co-processor. Whether an object can be considered to be offloaded partially or entirely on the audio co-processor depends on the responsibilities of that object. For example, as indicated, the connection buffers (120) of the objects store (116) have been partially offloaded from the CPU of the computing device to the audio co-processor. In order for the audio co-processor to access the connection buffers (120) to run the pump pass, the connection buffers (120) can be allocated from RAM that is accessible to the audio co-processor. Metadata for the connection buffers (120), however, should be accessible to the CPU which participates in building the audio device graph (118). Thus, because both the CPU and the audio co-processor require access to certain aspects of the connection buffers (120), the connection buffers (120) are considered to have been partially offloaded to the audio co-processor in the example.

In some examples, partially offloading a connection buffer (120) from the CPU to the audio co-processor can include configuring the connection buffer (120) such that it is made available to both the CPU and the audio processor (128) of audio pump (126). For example, during allocation of a connection buffer (120), a parameter can be set to indicate whether the connection buffer (122) should be made available to the CPU only, the audio processor (128) of the audio pump (126) only, or both the CPU and the audio processor (128). If a connection buffer (122) is to be made available to both the CPU and the audio processor (128) (i.e., partially offloaded from the CPU), the connection buffer (122) is marked as a “CPU and audio co-processor” buffer and is shared between the CPU and the audio co-processor (128). Accordingly, the CPU (e.g., the portions of builder (106) executing on the CPU) and the audio co-processor (128) will both be able to read and write from the connection buffer (122).

In contrast, connection buffers (122) which are not offloaded are marked as “CPU only” buffers and are not visible to the audio co-processor (128), and connection buffers which are entirely offloaded to the audio co-processor (128) are marked as “audio co-processor only” buffers and are only visible to the audio co-processor (128). In the latter case, the address of the audio co-processor (128) will be made available to the CPU, but the CPU will not actually read or write to these buffers. As indicated, the APOs (122) have also been partially offloaded from the CPU of the computing device to the audio co-processor. (That is, the APO(s) are part of a processing pipeline created by the audio co-processor and execute on the audio co-processor, but the APO(s) are accessible to the CPU.) Each APO (122) has a configuration interface and a streaming interface. The configuration interface, which is driven by the CPU, is an interface used for initialization, format negotiation, and notifications. The configuration interface can optionally include additional functionality that allows users to customize and adjust the settings or parameters of the APO (122) via the CPU. In contrast, the streaming interface is an interface used for audio processing and thus should be accessible to the audio co-processor. The streaming interface can be configured to facilitate continuous, real-time transmission and processing of streams of audio data.

In some examples, partially offloading an APO (122) from the CPU to the audio co-processor can include first creating an instance of an APO (122) on the CPU, and then instantiating an audio co-processor instance of the APO (122) on the audio co-processor. Initialization parameters and other information can be communicated between the CPU and audio co-processor instances of the APO (122), e.g., via the configuration interface of the audio co-processor instance of the APO (122). Communication between the two instances can be performed using a memory safe lock-free mechanism to ensure memory consistency.

Further, as indicated, audio processor (128) has been partially offloaded from the CPU of the computing device to the audio co-processor. The audio processor (128) is an object that includes data structures that determine the topology of the audio device graph (118). In this context, the term “topology” refers to the arrangement or structure of audio processing components that collectively form the audio device graph (118). The topology of the graph, which is managed by the CPU, is updated as audio streams are created or destroyed. The audio processor (128) is also used by the audio pump to run the processing pass on a current snapshot of the topology of the audio device graph (118). As a result, the audio processor (128) includes both a CPU component and an audio co-processor component, and thus is moved partially to the audio co-processor.

In contrast, as indicated, the audio pump (126) and the endpoint object (124) have been entirely offloaded from the CPU to an audio co-processor. The audio pump (126) provides the execution environment for the pump thread and is responsible for waking up on the appropriate interrupts and providing the execution thread for the pump. As the CPU is not involved with the processes occurring in the execution environment for the pump thread, the audio pump (126) can be moved in entirety to the audio co-processor (e.g., created by and executed on the audio co-processor). The endpoint object (124) provides the interrupts and buffers to be written to by the pump (e.g., shared buffer (110)). As these aspects of the builder (106) are not of interest to the CPU, the endpoint object (124) can be entirely (e.g., fully) offloaded to the audio co-processor.

While a single audio co-processor is discussed herein for the sake of brevity, it is contemplated that multiple audio co-processors can be used in some examples. For example, components that have been offloaded from the CPU to an audio co-processor can alternatively be divided up such that a first subset of the components are offloaded a first audio co-processor, a second subset of the components are offloaded to a second audio co-processor, etc., for any number of audio co-processors.

In some examples, the audio co-processor(s) are part of the same computing device as the CPU. For example, the computing device can be a laptop computer, desktop computer, tablet, or gaming device, among other devices, which includes a CPU and one or more audio co-processors, among other components. In other examples, the audio co-processor(s) are not part of the same computing device as the CPU, but rather communicate with the CPU via a wired or wireless connection.

While the audio processing flow (100) is described in the context of a computing device, in some examples, some or all of the components involved in the audio processing flow (100) are connected over a network using an appropriate communication protocol. The network can include the Internet or another computer network.

C. Example Advantages of Offloading an Audio Pump from a CPU to an Audio Co-Processor.

There are numerous technical advantages associated with the disclosed techniques for offloading an audio pump from the CPU to an audio co-processor.

As one example, offloading the audio pump to the audio co-processor has the technical effect of reducing the load on the CPU. For example, in a computing device comprising a CPU and an audio co-processor, the CPU can receive a request from an application to add an audio stream to a device graph associated with an audio endpoint. Responsive to receiving the request, the CPU can modify the device graph to incorporate the audio stream, e.g., by causing the audio co-processor to create a processing pipeline comprising an APO for the audio stream in the device graph, such that the APO is offloaded to the audio co-processor. The CPU can then direct the audio co-processor to process the audio stream with the modified device graph. With offloading of the APO to the audio co-processor, since the audio co-processor handles the load associated with the audio stream instead of the CPU, the load on the CPU is reduced.

As another example, because the relevant code running on the audio co-processor can be controlled by the operating system of the computing device (e.g., via the configuration interfaces of the APOs), it is easier to update the algorithms of the APOs and the topology of the device graph.

Further, the disclosed techniques allow for updating existing application-facing APIs, which in turn allows for the technical effect of energy savings via more power-efficient signaling. For example, when one client is being signaled, all other clients can opportunistically be signaled to coalesce CPU wakes. In other examples, clients can be signaled only when a low watermark is reached, to avoid excessive wake ups for an application.

In addition, the disclosed techniques advantageously allow for multiple concurrent audio endpoint use without disadvantages such as relatively high latency or power use. In some examples, an operating system of a computing device can advantageously switch between using a CPU-based audio pump and an audio co-processor-based audio pump.

### II. Example Audio Device Graph Builders

Example audio device graph builders are shown in FIGS. 2-4. The audio device graph builders can each be carried out on a computing device comprising a CPU and an audio co-processor and can correspond to audio device graph builder (106) of FIG. 1.

The particular arrangements and numbers of components shown in FIGS. 2-4 are provided for exemplary purposes only, to illustrate example topologies of an audio device graph. Other arrangements and numbers of components (e.g., other numbers of audio streams, shared buffers, communications streams, media streams, APOs, connection buffers, endpoints, etc.) are also contemplated.

### A. Example Audio Device Graph for Render Scenarios.

An example audio device graph builder (200) for a render scenario is shown in FIG. 2. A render scenario may occur when one or more applications produce audio streams for rendering to an endpoint (e.g., speakers or a headset).

Similar to audio device graph builder (106), audio device graph builder (200) includes an audio device graph (202), and a device graph objects store (216). Audio device graph (202) includes an audio pump (126), an audio processor (228), and an endpoint object (224). While the APOs and connection buffers are depicted within audio device graph (202) for illustrative purposes, it will be appreciated that these objects are stored in the device graph objects store (216) and accessed by the audio device graph (202) after it is initialized with a reference to the device graph objects store (216).

In the example, audio streams are received from one or more applications at three shared buffers for processing. Each shared buffer is accessible to the builder (200) as well as to an application originating an audio stream. The three audio streams can be transmitted from three different applications (e.g., one stream per application), from two different applications (e.g., one stream from one application, two streams from another application), or from the same application (e.g., all three streams output by one application). In other examples, another number of audio streams can be received at a corresponding number of shared buffers, from any number of different applications. As noted above with reference to FIG. 1, the shared buffers can alternatively be referred to as “cross-process” buffers.

The three example render audio streams received at audio device graph (202) via the corresponding shared buffers include two communications audio streams (e.g., audio streams associated with a conferencing application) and one media audio stream (e.g., an audio stream from a music player or web browser). The two communications audio streams undergo separate processing via a series of APOs connected by connection buffers and then are combined in into a single audio stream. Meanwhile, the single media audio stream undergoes processing via a series of APOs connected by connection buffers before being combined with the audio stream resulting from the combination of the two communications audio streams. The resulting combined audio stream then undergoes further processing before it is transmitted to a shared buffer accessible to a device driver of an endpoint. In the example, the endpoint is a render endpoint which outputs an audio stream, such as speakers or a headset.

Different processing pipelines, each comprising a series of APOs connected by connection buffers, can be customized for different audio processing scenarios. For example, a processing pipeline of APOs and connection buffers can be built that is customized for media processing, and another processing pipeline of APOs and connection buffers can be built that is customized for communications processing. The media pipeline can be tuned for processing dialogs or music, whereas the communications pipeline can be tuned for voice and include functionality such as noise suppression.

The audio service (e.g., audio service (102) of FIG. 1) can be configured to manage the generation of a customized pipeline for an application in response to a request for an audio stream received from the application. For example, the audio service can assess the capabilities of the computing device and/or the endpoint(s) to determine which APOs should be included in the pipeline. The audio service can then send that information to the audio device graph builder (e.g., builder (106) of FIG. 1) and request that the audio device graph builder build a graph accordingly.

As discussed above with reference to FIG. 1, builder (200) includes objects that have been partially offloaded to an audio co-processor, as well as objects that have been entirely offloaded to an audio co-processor. For example, the connection buffers and APOs, which are stored within device graph objects store (216), have been partially off-loaded to an audio co-processor. The audio processor object (228), which includes the actual mixing logic and ensures that the APOs are invoked in the correct order to execute a pump pass, is also partially off-loaded to the audio co-processor. In contrast, the audio pump (226) and endpoint object (124) have been entirely offloaded to the audio co-processor.

### B. Example Audio Device Graphs for Render and Capture Scenario.

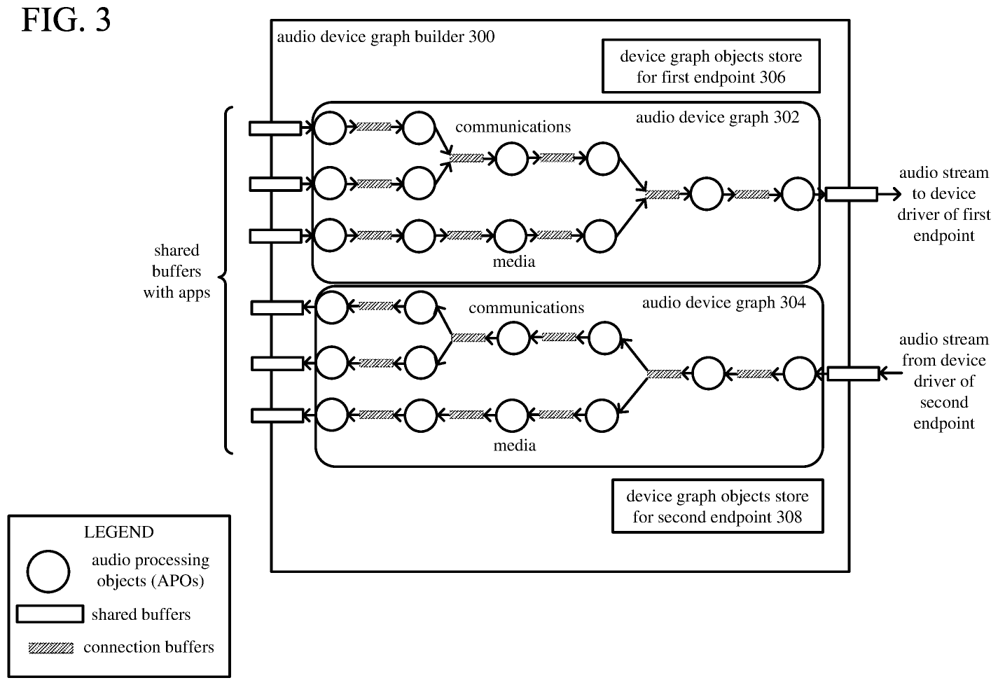

An example audio device graph builder (300) including audio device graphs for a render and capture scenario is shown in FIG. 3. A render and capture scenario may occur when a user participates in a conference call via a conferencing application or when a user participates in a chat session during gameplay on a gaming console, for example.

Audio device graph builder (300) includes an audio device graph (302) for a first endpoint and an audio device graph (304) for a second endpoint. Audio device graph builder (300) further includes a device graph objects store (306) for the first endpoint which stores the APOs and connection buffers used in audio device graph (302), and a device graph objects store (308) for the second endpoint which stores the APOs and connection buffers used in audio device graph (304). While not depicted in FIG. 3, each audio device graph can also include an audio pump, an audio processor, and an endpoint object.

In the example, audio device graph builder (300) receives a total of six audio streams via six shared buffers. Three of the shared buffers transmit audio streams to audio device graph (302), and the other three shared buffers transmit audio streams to audio device graph (304). The depicted number of audio streams is arbitrary; other numbers of audio streams are equally possible. For example, each of the audio device graphs could receive more or fewer audio streams, and the audio device graphs could receive different numbers of audio streams.

Similar to audio device graph (202) of FIG. 2, the three render audio streams received at audio device graph (302) via the corresponding shared buffers include two communications audio streams and one media audio stream. The two communications audio streams undergo separate processing via a series of APOs connected by connection buffers and then are combined into a single audio stream, while the single media audio stream undergoes processing via a series of APOs connected by connection buffers before being combined with the combined communications audio stream. The resulting combined audio stream then undergoes further processing before it is transmitted to a shared buffer accessible to a device driver of the first endpoint. In the example, the first endpoint is a render endpoint which outputs an audio stream, such as speakers or a headset, whereas the second endpoint is a capture endpoint which receives an audio stream from an audio capture device such as a microphone.

Now turning to audio device graph (304), the captured audio stream is received from a device driver of the second endpoint at a shared buffer and transmitted to the audio device graph (304) for processing. In the example, the captured audio stream is processed via a series of APOs connected by connection buffers before being split into two separate streams. In particular, the captured audio stream is split into a communications stream, which later diverges into two communications streams, and a media stream. The media stream undergoes processing via a series of APOs connected by connection buffers and then is transmitted to a shared buffer accessible to a media application (e.g., a voice recorder application).

Similarly, after the communications stream diverges, the resulting two communications streams each undergo processing via a respective series of APOs connected by connection buffers and then are transmitted to respective shared buffers that are accessible to a communications application (e.g., a conferencing application). In some examples, the two shared buffers receiving the communications streams are accessed by the same application; in other examples, they are each accessed by different applications.

### C. Example Audio Device Graph for Render and Loopback Scenario.

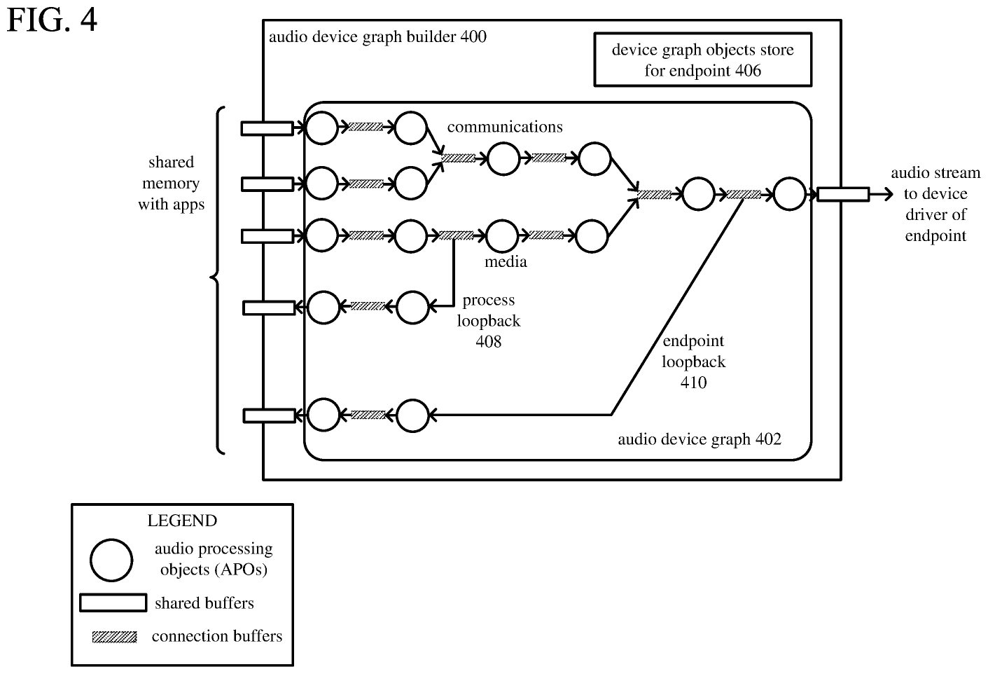

An example audio device graph builder (400) including audio device graphs for a render and loopback scenario is shown in FIG. 4. Loopback can be added to an audio device graph by the audio service when an application wants to receive the same audio stream that is received at an endpoint, e.g., for audio monitoring purposes or so that the application can perform AEC.

Audio device graph builder (400) includes an audio device graph (402) for an endpoint, along with a device graph objects store (406) for the endpoint which stores the APOs and connection buffers used in audio device graph (402). While not depicted in FIG. 4, audio device graph (402) can also include an audio pump, an audio processor, and an endpoint object.

Similar to audio device graph (302) of FIG. 3, audio device graph (402) receives three render audio streams via corresponding shared buffers, including two communications audio streams and one media audio stream. The two communications audio streams each undergo separate processing via a series of APOs connected by connection buffers and then are combined into a single audio stream, while the single media audio stream undergoes processing via a series of APOs connected by connection buffers before being combined with the combined communications audio stream. The resulting combined audio stream then undergoes further processing before it is transmitted to a shared buffer accessible to a device driver of the endpoint. In the example, the endpoint can be a render endpoint which outputs an audio stream, such as speakers or a headset.

As shown, audio device graph (402) also includes loopback streams. In particular, the media audio stream diverges at one of the connection buffers and the diverging portion undergoes processing via two APOs connected by a connection buffer before being transmitted to a shared buffer accessible to an application. This diverging portion of the audio stream is referred to as a process loopback (408).

Further, the combined audio stream diverges at the final connection buffer, prior to the final APO, and then undergoes processing via two APOs connected by a connection buffer before being transmitted to another shared buffer accessible to an application. The path taken by this diverging audio stream is referred to as an endpoint loopback (410).

In the example, the final APO in the audio device graph (402) is a format converter APO which converts floating point data to integer data; accordingly, the audio stream diverges prior to the final APO in order to provide floating point data to the two APOs in the endpoint loopback (410).

In other examples, the audio streams can diverge at different portions of the audio device graph (402) to form different loopbacks, and the audio device graph (402) can include a different number of loopbacks than what is depicted in FIG. 4. Further, different numbers of APOs and/or connection buffers can be arranged in the loopbacks, and in the audio device graph (402), than those depicted.

### D. Other Example Graph Topologies

Other types of graph topologies can be used in addition to, or instead of, the example graph topologies shown in FIGS. 2-4. For example, cross-device topologies can be used which include a loopback reference input for APOs such as AEC APOs. As another example graph topologies can be created which allow for audio mirroring from one device to another.

In examples where spatial audio processing is performed, the graph topology can be configured such that an APO can write to two output buffers, one for buffering and one for loopback. Further, graph topologies can be reconfigured under a running audio stream.

### III. Example Audio Pump Thread

A technique (500) representing an example audio pump thread is shown in FIG. 5. Technique (500) can be performed by an audio pump that has been offloaded from a CPU to an audio co-processor, such as audio pump (126) of FIG. 1.

First, technique (500) includes waiting (502) for a buffer completion signal from a device driver of an endpoint. The endpoint can be an audio peripheral device such as speakers, a headset, or a microphone. The device driver can be configured to send a buffer completion signal when it is ready to receive more audio data in a shared buffer for rendering, or when it is ready to transmit captured audio from a shared buffer to the audio device graph associated with the endpoint for processing.

Upon receipt of a buffer completion signal, the technique proceeds to process (504) the APOs of the audio device graph for the endpoint in order (e.g., in the sequence dictated by the audio device graph). For example, the APOs in an audio device graph can be processed in an order determined by the audio device graph builder and reflected in the configuration of inputs and outputs for the APOs, respectively. After the APOs are processed in the specified order, the technique returns to (502).

Technique (500) continues to loop while an audio stream is active for the endpoint. Once no active audio streams remain for the endpoint, technique (500) ends.

It will be appreciated that each active audio stream can have its own pump thread. Accordingly, at a given time, multiple pump threads can be executing. For example, a conferencing application may have a render stream, capture stream, and loopback stream running at the same time, such that three pump threads (one per stream) are executing at the same time.

### A. Audio Pump Cadence Selection.

Every application has its own natural cadence. For example, a music application may want to submit 1 s buffers because it is reading data from a file on disk or because it has downloaded an entire song. Communication applications (e.g., conferencing applications) may want to submit or receive 20 ms buffers (to match the duration of audio packets sent/received over network). Games may want to operate with 10 ms buffers to minimize latency, whereas a pro-audio creation application may want to operate at 3-5 ms for good touch-to-ear response. Ideally, the audio pump runs no faster than the speed requested by the fastest client.

When a relatively fast pump cadence (e.g., 3-5 ms) is used for a CPU-based audio pump, audio processing can be performed with a relatively low latency. However, power efficiency is reduced and glitch susceptibility is increased. In contrast, when a relatively slow pump cadence (e.g., >50 ms) is used for a CPU-based audio pump, power efficiency and glitch resiliency are improved. However, latency is increased and the system will respond more slowly to audio stream property changes such as volume changes.

A typical pump cadence used for CPU-based audio pumps is 10 ms, which provides a reasonable tradeoff between power efficiency and latency. However, in certain scenarios requiring multiple concurrent pump threads, such as communications scenarios with concurrent render, capture, and loopback streams, a 10 ms pump cadence can potentially keep the CPU running constantly (e.g., the CPU is prevented from entering a lower power state).

As described below, offloading the audio pump from the CPU to the audio co-processor in accordance with the disclosed techniques can allow the pump to run at a cadence faster than 10 ms without suffering from the drawbacks associated with use of a similar pump cadence for a CPU-based audio pump.

### B. Example Pump Cadence for Audio Pump Offload Scenario.

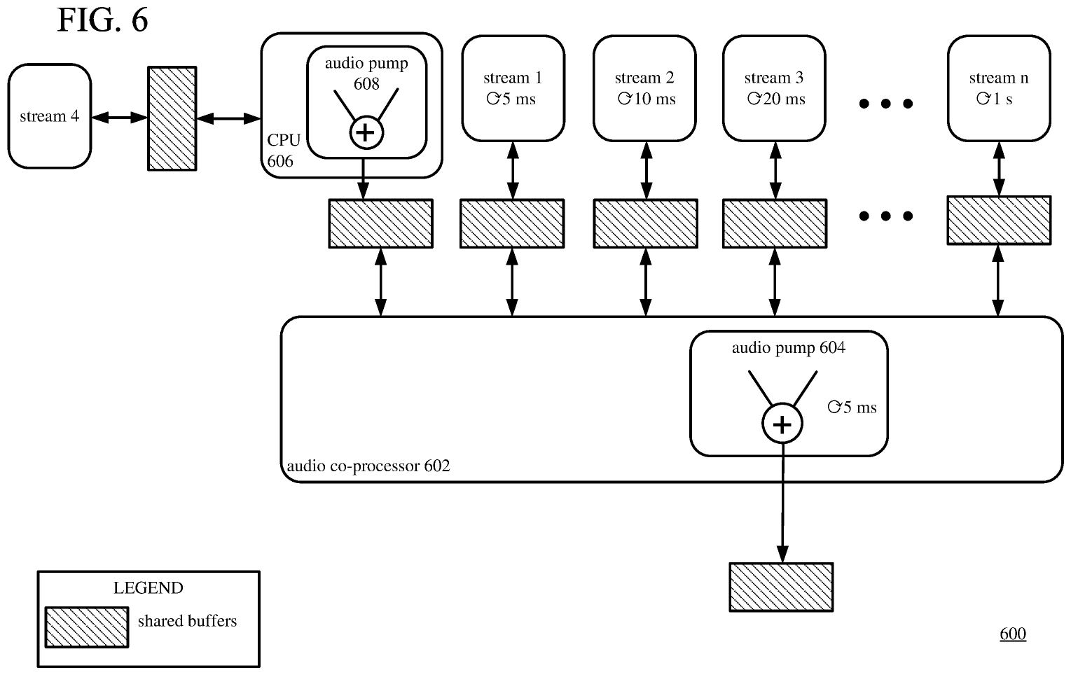

FIG. 6 is a diagram (600) of an audio co-processor (602) processing audio streams at an example pump cadence of 5 ms. In the example, audio streams 1 . . . n have been offloaded from a CPU of a computing device to the audio co-processor (602). Certain aspects of the audio device graph builder of the computing device have been partially or entirely offloaded to audio co-processor (602). For example, as shown, an audio pump (604) has been entirely offloaded from the CPU to the audio co-processor (602).

In the example, streams 1 . . . n each have different preferred buffer durations. In particular, stream 1 has a preferred buffer duration of 5 ms, stream 2 has a preferred buffer duration of 10 ms, stream 3 has a preferred buffer duration of 20 ms, and stream n has a preferred buffer duration of 1 s.

As the CPU and the audio pump (604) use different compute resources and thus are not competing for compute resources, the pump thread for audio pump (604) can run reliably at a predictable and relatively fast cadence. In addition, the CPU can remain in a low power (e.g., sleeping) state until a given application needs to wake up to supply or receive data, and each application only needs to wake up at their preferred cadence.

In the example, a pump cadence of 5 ms is used. In other examples, a lower or higher pump cadence can be used (e.g., any pump cadence greater than 0 ms).

### C. Implementing a Fallback Audio Pump on the CPU.

In some examples, the CPU of a computing device can also be used as an audio co-processor. In this scenario, a new process is launched on the CPU which mimics the process that would be carried out by a standalone audio co-processor. For example, an operating system of a computing device can be configured to switch between using a CPU-based audio pump and an audio co-processor-based audio pump, or to use a CPU-based audio pump as needed if an audio co-processor lacks sufficient resources. Towards this end, the audio device graph builder can be configured to implement a fallback audio pump on the CPU to augment the capabilities of the audio co-processor, which may have limited resources. In such examples, the CPU can be considered a catch-all audio co-processor that supports all audio pumps for all audio endpoints. Optionally, the audio stack can be re-factored to treat the CPU as a special case audio co-processor (602).

Diagram (600) shows an example CPU (606) which can implement an audio pump (608) when the resources of the audio co-processor (602) are not adequate for the requested audio stream(s). In the example, stream 4 is processed by the audio pump (608) on the CPU (606), before being combined with one or more of the other streams at the audio co-processor. This configuration advantageously allows the compute resources of the CPU (606) to supplement those of the audio co-processor (602) in circumstances where the requested audio stream(s) cannot be adequately processed by the audio co-processor (602) alone. While the audio pump (608) and the audio pump (604) are shown in a cascade arrangement, other arrangements are also possible. While a single stream is shown in the example, in other examples multiple streams can be processed by CPU (606). Alternatively, as described herein, all streams can be processed by the audio co-processor.

In the example, stream 4 is associated with the same shared output buffer, and thus the same audio endpoint, as the streams that are processed on the audio co-processor (602). However, stream 4 or any of the other streams can alternatively be associated with a different audio endpoint.

### IV. Example Audio Stack for Offloading Objects from CPU to Audio Co-Processor

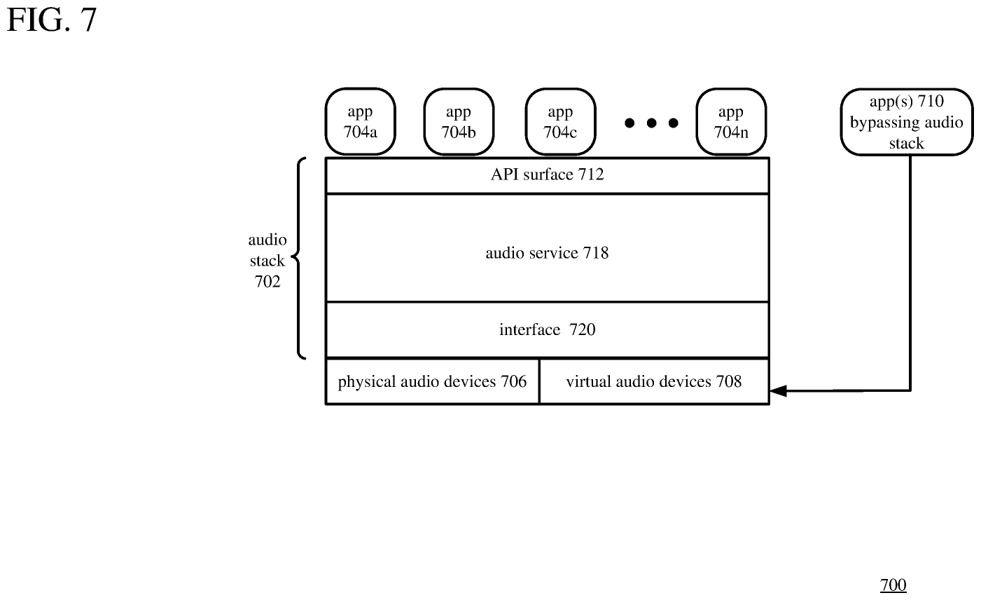

The audio hardware present on a computing device is sometimes referred to as the “audio stack” for the device. FIG. 7 shows an example audio system (700) for a computing device which includes an audio stack (702). Audio stack (702) can transmit audio streams to and from applications (apps) (704a . . . n) and perform processing on the audio streams. Further, audio stack (702) can transmit processed audio streams to physical audio devices (706) and virtual audio devices (708) for rendering and receive captured audio streams from physical audio devices (706) and virtual audio devices (708) for processing and transmission to one or more of apps (704a . . . n). Audio system (700) can also include one or more apps (710) which bypass the audio stack (702).

Apps (704a . . . n) can include any applications which involve render or capture of audio. Rendering audio refers to playback of audio, e.g., via an audio endpoint with output capabilities such as speakers or headphones. Capturing audio refers to recording audio, e.g., via an audio endpoint capable of recording audio data such as a microphone. For example, the apps (704a . . . n) which involve rendering and/or capturing audio can include web browser applications, music player applications, voice recorder applications, conferencing applications, and/or gaming applications. Or, one or more of the apps (704a . . . n) can include be an application where audio is not a primary experience, but instead is a “companion” experience. Apps (704a . . . n) can also include applications for accessibility, such as a narrator application or a screen reader application, as well as modern virtual assistant applications that constantly listen to the microphone and wait to be woken up when a user speaks a particular keyword.

Physical audio devices (706) can include physical audio hardware that the user has integrated into their computing device, such as integrated speakers or microphones. Additionally or alternatively, physical audio devices (706) can include devices that the user plugs into their computing device such as USB speakers, USB microphones, BLUETOOTH® devices, devices connected via High Definition Multimedia Interface (HDMI), etc.

Virtual audio devices (708) can include devices that do not include physical audio hardware, such as a remote endpoint accessed by a user when the user remotes into a work computer from home, or a Miracast endpoint which allows a laptop to connect wirelessly to a Miracast display and route computer audio to the display.

As used herein, the term “audio endpoint” or simply “endpoint” can refer to either physical audio devices or virtual audio devices.

### A. Example Audio Stack Architecture

As shown in FIG. 7, audio stack (702) conceptually sits between apps (704a . . . n) and the audio endpoints (e.g., physical audio devices (706) and virtual audio devices (708). An API surface (712) is disposed at the top of the audio stack (702). API surface (712) presents APIs to apps (704a . . . n). In some examples, the APIs can include, for example, APIs that allow applications to discover and enumerate audio endpoints; APIs which allow applications to create audio streams and stream audio buffers to the operating system; and spatial audio APIs that allow applications to stream spatial audio to the operating system to provide a more immersive user experience for scenarios such as gaming or movie watching.

Below the API surface (712), the audio stack (702) includes one or more operating system components configured to build a device graph (e.g., so that two or more of apps (704a . . . n) can share an audio endpoint). These components can include an audio service (718). Audio service (718), which corresponds to audio service (102) of FIG. 1, can launch an audio device graph builder (e.g., audio device graph builder (106) of FIG. 1) to stream audio to and from applications and devices.

An interface (720) is provided below the audio service (718) at the lower edge of the audio stack (702). Interface (720) can include audio drivers configured to manage the audio hardware for physical audio peripheral devices.

The depicted components of audio stack 702 are provided for illustrative purposes and are not intended to be comprehensive. In practice, audio stack 702 can include other components which are not shown in FIG. 7.

B. Modifications to the Audio Stack to Support Offloading Objects from the CPU to the Audio Co-Processor.

To support offloading objects from the CPU of a computing device to an audio co-processor, the audio stack of the computing device can be modified, relative to a typical audio stack, to handle several different hardware configurations. As a first example, the audio stack can be modified to handle a configuration in which the audio co-processor can be used by a specified maximum number of endpoints concurrently. As a second example, the audio stack can be modified to handle a configuration in which the computing device has multiple audio co-processors, each of which can be used by a specified maximum number of endpoints concurrently. As a third example, the audio stack can be modified to handle a configuration in which one or more audio co-processors have constraints on the types of endpoints which are offloaded. The constraints can include, for example, a constraint that an audio co-processor will handle integrated endpoints but not Universal Serial Bus (USB) or BLUETOOTH® endpoints.

The audio stack can also be modified to ensure that certain specified relationships between audio co-processors and endpoints are maintained. As a first example, the audio stack can be configured to specify, for each audio co-processor, the types of audio endpoints for which the audio pump can be offloaded to the audio co-processor (e.g., in the manner described above with reference to audio device graph builder (106) of FIG. 1). As a second example, the audio stack can be configured to specify, for each audio endpoint, a list of audio co-processors to which the audio pump for that endpoint can be offloaded. Accordingly, the operating system can keep track of how many co-processors exist and maintain a mapping of which audio endpoints can be offloaded to which audio co-processors. The relationship can be many-to-many, such that an audio co-processor can support one endpoint or more than one endpoints (e.g., all endpoints). Conversely, an endpoint may be able to be supported by zero audio co-processors, or by one or more audio co-processors.

### V. Example Techniques for Processing an Audio Stream

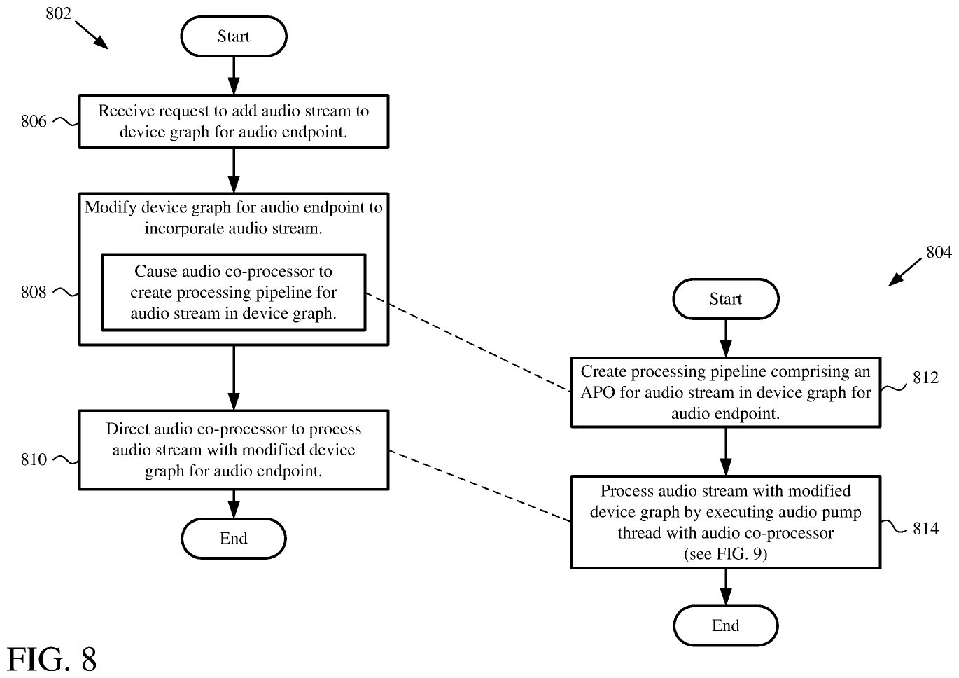

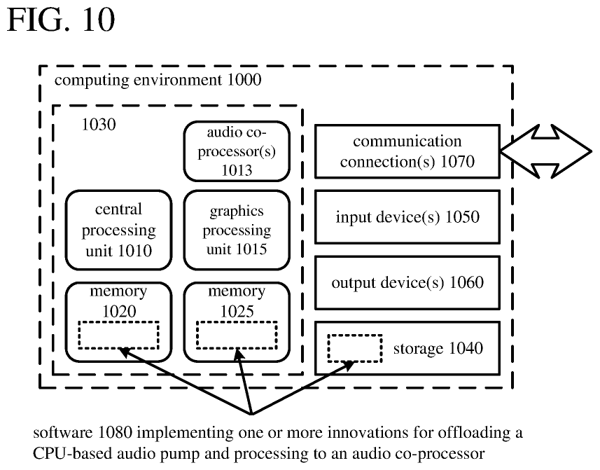

FIG. 8 depicts generalized techniques (802) and (804) for configuring and implementing an audio device graph for an audio stream. Technique (802) includes actions performed by the CPU, while technique (804) includes actions performed by the audio co-processor. A computing device comprising a CPU and an audio co-processor, such as computer system (1000) described below with reference to FIG. 10, can perform the techniques (802) and (804). Alternatively, a computing device comprising a CPU can perform (technique802) in concert with performance of technique (804) by an audio co-processor external to the computing device (e.g., a third-party audio co-processor).

Turning first to technique (802), a request is received (806) to add an audio stream to a device graph for an audio endpoint. The request can be received from an audio service process, such as audio service (102) described above for FIG. 1. In some examples, the request is initiated by an application which will be rendering or capturing the audio stream via the audio endpoint and then relayed by the audio service.

In response to the request, a device graph for the audio endpoint is modified (808) to incorporate the audio stream. As described herein, the device graph can include a series of APOs linked via connection buffers. Modifying the device graph to incorporate the audio stream can include creating a new device graph for the audio endpoint, or modifying an existing device graph for the endpoint to incorporate the audio stream. Example topologies of device graphs are shown in FIGS. 2-4. As discussed herein, a device graph builder accessible to the CPU as well as the audio co-processor can be used to modify the device graph.

In the example, modifying the device graph for the audio endpoint includes causing (808) an audio co-processor to create a processing pipeline for the audio stream in the device graph. For example, an audio service executing on the CPU can be configured to manage or supervise audio streams for the computing device. Towards that end, the audio service can direct an audio co-processor on the computing device, or an external audio co-processor, to perform functions such as creation of a processing pipeline for an audio stream.

Optionally, technique (802) can also include creating a shared buffer for the audio stream in response to the request (e.g., prior to modifying the device graph for the audio endpoint). In a render scenario, the shared buffer created can be an application-side shared buffer (e.g., a cross-process buffer accessible to the application associated with the audio stream as well as to the audio device graph builder process). In some examples, a corresponding endpoint-side shared buffer for the endpoint already exists, and thus is not created at this stage. In other examples, such as when no other audio device graphs exist for the endpoint, an endpoint-side shared buffer can also be created at this stage.

Next, the CPU directs (810) the audio co-processor to process the audio stream with the modified device graph for the audio endpoint. (810) an audio pump thread to process the audio data with the audio device graph. This can include the CPU or a component thereof (e.g., an audio service executing on the CPU) managing or supervising the processing of the audio stream performed by the audio co-processor on an ongoing basis, or simply causing the audio co-processor to process the audio stream or start processing the audio stream until further notice. After (810), technique (802) ends.

Returning to technique (804), it includes the audio co-processor creating (812) a processing pipeline comprising an APO for an audio stream in a device graph for an audio endpoint. As indicated by the dashed line, this step can be performed in conjunction with step (808) of technique (802). For example, the CPU causes the audio co-processor to create a processing pipeline for the audio stream in the device graph for the audio endpoint at (808), and thus the audio co-processor creates the processing pipeline at (812).

Next, the audio co-processor processes (814) the audio stream with the modified device graph (e.g., the device graph that was modified via the creation of the processing pipeline at (812)) by executing an audio pump thread. As indicated by the dashed line, this step can be performed in conjunction with step (810) of technique (802). For example, the CPU directs the audio co-processor to process the audio stream with the modified device graph for the audio endpoint at (810), and thus the audio co-processor processes the audio stream accordingly at (814).

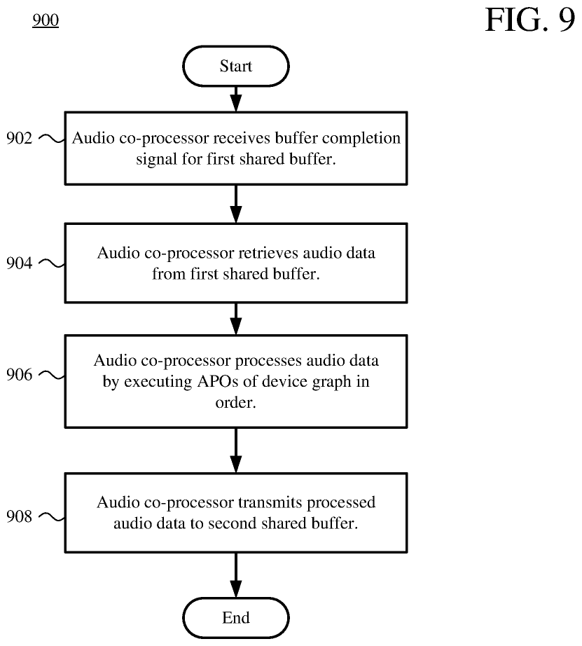

FIG. 9 depicts a generalized technique (900) for executing an audio pump thread on an audio co-processor to process an audio stream. As indicated above, technique (900) can be performed at step (814) of technique (804). The audio pump thread can correspond to the audio pump thread described above for FIG. 5.

First, the audio co-processor receives (902) a buffer completion signal for a first shared buffer. The buffer completion signal can indicate that the first shared buffer is full of audio data from an audio stream and ready to be emptied so that it can be filled with additional audio data from the audio stream. The first shared buffer can be an application-side shared buffer for a render scenario, or an endpoint-side shared buffer for a capture scenario, for example.

The audio co-processor retrieves (904) the audio data from the first shared buffer upon receipt of the buffer completion signal. The audio co-processor then processes (906) the audio data retrieved from the first shared buffer by executing the APOs of the device graph for the audio endpoint associated with the audio stream in order. As described herein, the APOs of the device graph are partially offloaded from the CPU of the computing device to the audio co-processor. The audio co-processor can access a streaming interface of each APO to effect processing of the audio data at that APO.

Next, the audio co-processor transmits (908) the processed audio data for to a second shared buffer. In a rendering scenario, the second shared buffer can be an endpoint-side shared buffer, from which the processed audio data can be retrieved by a device driver of the audio endpoint and rendered. Alternatively, in an example where the audio stream is being captured at the endpoint, the second shared buffer can be an application-side shared buffer, from which the processed captured audio data can be retrieved by an application.

Techniques 802, 804, and 900 describe processing a single audio stream for explanatory purposes. In practice, as described herein, multiple audio streams can be processed in parallel by an audio co-processor at a given time.

### VI. Example Computer Systems

FIG. 10 illustrates a generalized example of a suitable computer system (1000) in which several of the described innovations may be implemented. The computer system (1000) is not intended to suggest any limitation as to scope of use or functionality, as the innovations may be implemented in diverse general-purpose or special-purpose computer systems.

With reference to FIG. 10, the computer system (1000) includes one or more processing units (1010, 1013, 1015) and memory (1020, 1025). In FIG. 10, this basic configuration (1030) is included within a dashed line. The processing units (1010, 1013, 1015) execute computer-executable instructions. A processing unit can be a general-purpose central processing unit (“CPU”), processor in an application-specific integrated circuit (“ASIC”) or any other type of processor. In a multi-processing system, multiple processing units execute computer-executable instructions to increase processing power. For example, FIG. 10 shows a CPU (1010) as well as one or more audio co-processor(s) (1013) and a graphics processing unit (“GPU”) (1015). In general, an audio co-processor (1013) can be a DSP, other specialized circuit, or another type of processing unit configured to process audio data as described herein. The audio co-processor (1013) can be implemented as part of a dedicated sound card, as part of a motherboard, as part of a system on a chip (“SoC”), or in some other way (even on the same die as the CPU (1010)). In general, the GPU (1015) is any specialized circuit, different from the CPU (1010), that accelerates creation and/or manipulation of image data in a graphics pipeline. The GPU (1015) can be implemented as part of a dedicated graphics card (video card), as part of a motherboard, as part of a SoC, or in some other way (even on the same die as the CPU (1010)).

The tangible memory (1020, 1025) may be volatile memory (e.g., registers, cache, RAM), non-volatile memory (e.g., ROM, EEPROM, flash memory), or some combination of the two, accessible by the processing unit(s). In FIG. 10, the memory (1020) is CPU memory, accessible to the CPU (1010), and the memory (1025) is GPU memory, accessible to the GPU (1015). Depending on architecture (e.g., whether the GPU (1015) is part of a video card, motherboard, or SoC), the CPU memory can be completely separate from the GPU memory, or the CPU memory and GPU memory can, at least in part, be shared memory or drawn from the same source (e.g., RAM). The memory (1020, 1025) stores software (1080) implementing one or more innovations for recovering an overlay over video when using screen sharing with chroma subsampling, in the form of computer-executable instructions suitable for execution by the processing unit(s).

A computer system may have additional features. For example, the computer system (1000) includes storage (1040), one or more input devices (1050), one or more output devices (1060), and one or more communication connections (1070). An interconnection mechanism (not shown) such as a bus, controller, or network interconnects the components of the computer system (1000). Typically, operating system (“OS”) software (not shown) provides an operating environment for other software executing in the computer system (1000), and coordinates activities of the components of the computer system (1000).

The tangible storage (1040) may be removable or non-removable, and includes magnetic storage media such as magnetic disks, magnetic tapes or cassettes, optical storage media such as CD-ROMs or DVDs, or any other medium which can be used to store information and which can be accessed within the computer system (1000). The storage (1040) can store instructions for the software (1080) implementing one or more innovations for recovering an overlay over video when using screen sharing with chroma subsampling.

The input device(s) (1050) may be a touch input device such as a keyboard, mouse, pen, or trackball, a voice input device, a scanning device, or another device that provides input to the computer system (1000). For video, the input device(s) (1050) may be a camera, video card, screen capture module, TV tuner card, or similar device that accepts video input in analog or digital form, or a CD-ROM or CD-RW that reads video input into the computer system (1000). The output device(s) (1060) may be a display, printer, speaker, CD-writer, or another device that provides output from the computer system (1000).

The communication connection(s) (1070) enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, communication media can use an electrical, optical, RF, or other carrier.

The innovations can be described in the general context of computer-readable media. Computer-readable media are any available tangible media that can be accessed within a computing environment. By way of example, with the computer system (1000), computer-readable media include memory (1020, 1025), storage (1040), and combinations thereof. As used herein, the term computer-readable media does not include transitory signals or propagating carrier waves.

The innovations can be described in the general context of computer-executable instructions, such as those included in program modules, being executed in a computer system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computer system.

The terms “system” and “device” are used interchangeably herein. Unless the context clearly indicates otherwise, neither term implies any limitation on a type of computer system or computer device. In general, a computer system or computer device can be local or distributed, and can include any combination of special-purpose hardware and/or general-purpose hardware with software implementing the functionality described herein.

For the sake of presentation, the detailed description uses terms like “determine” and “perform” to describe computer operations in a computer system. These terms are high-level abstractions for operations performed by a computer, and should not be confused with acts performed by a human being. The actual computer operations corresponding to these terms vary depending on implementation.

### VII. Examples

The innovative features described herein include the following examples.

| | Example |
|---|---|
| A1 | In a computing device comprising a central processing unit (CPU) and an audio |
| | co-processor, a method comprising, with the CPU: |
| | receiving a request from an application to add an audio stream to a device |
| | graph, the device graph being associated with an audio endpoint; |
| | responsive to receiving the request, modifying the device graph to |
| | incorporate the audio stream, including causing the audio co-processor to create a |
| | processing pipeline for the audio stream in the device graph, the processing |
| | pipeline comprising an audio processing object (APO); and |
| | directing the audio co-processor to process the audio stream with the |
| | modified device graph. |
| A2 | The method of A1, wherein the APO comprises a configuration interface |
| | accessible to the CPU and a streaming interface accessible to the audio co- |
| | processor, wherein the APO is one of a plurality of APOs, and wherein the |
| | processing pipeline comprises the plurality of APOs and a plurality of connection |
| | buffers, the APOs being linked together by the connection buffers to form the |
| | processing pipeline. |
| A3 | The method of A2, wherein modifying the device graph to incorporate the audio |
| | stream further comprises allocating the connection buffers from memory |
| | accessible to the audio co-processor, and wherein metadata for the connection |
| | buffers is accessible to the CPU. |
| A4 | The method of any one of A1-A3, further comprising, responsive to receiving the |
| | request, with the CPU: |
| | creating an application-side shared buffer for the audio stream, the |
| | application-side shared buffer being accessible to the application and the audio co- |
| | processor. |
| A5 | The method of any one of A1-A4, wherein the audio endpoint is a render audio |
| | endpoint, the method further comprising, with the CPU: |
| | receiving a request to add a capture audio stream to a device graph for a |
| | capture audio endpoint; |
| | responsive to receiving the request to add the capture audio stream: |
| | creating an endpoint-side shared buffer for the capture audio |
| | stream, the endpoint-side shared buffer being accessible to the capture |
| | audio endpoint and the audio co-processor; and |
| | modifying the device graph for the capture audio endpoint to |
| | incorporate the capture audio stream, including causing the audio co- |
| | processor to create a processing pipeline for the capture audio stream in the |
| | device graph for the capture audio endpoint; and |
| | directing the audio co-processor to process the capture audio stream with |
| | the modified device graph for the capture audio endpoint. |
| A6 | The method of any one of A1-A5, wherein the audio endpoint is a render audio |
| | endpoint and the audio stream is a render audio stream, the method further |
| | comprising, with the CPU: |
| | receiving a request to add a loopback stream to the device graph for the |
| | render audio endpoint; |
| | responsive to receiving the request to add the loopback stream: |
| | creating an application-side shared buffer for the loopback stream, |
| | the application-side shared buffer for the loopback stream being accessible |
| | to the render audio endpoint and the audio co-processor; and |
| | modifying the device graph for the render audio endpoint to |
| | incorporate the loopback stream, including causing the audio co-processor |
| | to create a processing pipeline for the loopback stream in the device graph |
| | for the render audio endpoint that branches off from the processing |
| | pipeline for the render audio stream; and |
| | directing the audio co-processor to process the loopback stream, along with |
| | the render audio stream, with the modified device graph for the render audio |
| | endpoint. |
| A7 | The method of any one of A1-A6, wherein modifying the device graph to |
| | incorporate the audio stream further comprises determining a topology of the |
| | device graph with a CPU-based component of an audio processor object of the |
| | device graph, and wherein the topology comprises a list of APOs and connection |
| | buffers in the processing pipeline. |
| B1 | One or more non-transitory computer-readable media having stored thereon |
| | computer-executable instructions for causing an audio co-processor of a |
| | computing device, when programmed thereby, to perform operations comprising: |
| | responsive to a request from an application to add an audio stream to a |
| | device graph, with the audio co-processor, creating a processing pipeline for the |
| | audio stream in the device graph, the processing pipeline comprising an audio |
| | processing object (APO), and the device graph being associated with an audio |
| | endpoint; and |
| | processing the audio stream with the device graph by executing an audio |
| | pump thread with the audio co-processor. |
| B2 | The one or more computer-readable media of B1, wherein the computing device |
| | further comprises a central processing unit (CPU), wherein processing the audio |
| | stream with the device graph by executing the audio pump thread with the audio |
| | co-processor comprises reading audio data for the audio stream from a shared |
| | buffer accessible to the CPU and the audio co-processor, and wherein the audio |
| | data is read from the shared buffer before any processing on the audio data is |
| | performed by the CPU. |
| B3 | The one or more computer-readable media of B1 or B2, wherein the audio stream |
| | is a render audio stream, and wherein processing the audio stream with the device |
| | graph by executing the audio pump thread with the audio co-processor comprises: |
| | receiving a buffer completion signal from a device driver of the audio |
| | endpoint; |
| | responsive to receiving the buffer completion signal, initiating execution of |
| | the audio pump thread; and |
| | invoking the APO of the processing pipeline for the audio stream. |
| C1 | A computer system comprising: |
| | a central processing unit (CPU); |
| | an audio co-processor; |
| | memory accessible to both the CPU and the audio co-processor; and |
| | an audio device graph builder comprising: |
| | an objects store for an audio endpoint, the objects store comprising |
| | a connection buffer and an audio processing object (APO), the APO |
| | comprising a configuration interface accessible to the CPU and a streaming |
| | interface accessible to the audio co-processor; and |
| | a device graph for the audio endpoint, the device graph comprising |
| | an audio pump object executable on the audio co-processor. |
| C2 | The computer system of C1, wherein the audio pump object is configured to |
| | provide an execution environment for an audio pump thread, and wherein the |
| | audio pump object has been entirely offloaded to the audio co-processor and does |
| | not include any CPU-based component. |
| C3 | The computer system of C2, wherein the audio co-processor is configured to |
| | perform operations comprising: |
| | responsive to receiving a buffer completion signal from a device driver of |
| | the audio endpoint, initiating execution of the audio pump thread; and |
| | during the execution of the audio pump thread, invoking a processing |
| | pipeline for an audio stream, the processing pipeline comprising the APO and the |
| | connection buffer. |
| C4 | The computer system of C3, wherein the audio stream is a first audio stream, and |
| | wherein the audio co-processor is further configured to perform operations |
| | comprising: |
| | during the execution of the audio pump thread, invoking a processing |
| | pipeline for a second audio stream and a processing pipeline for a third audio |
| | stream. |
| C5 | The computer system of any one of C1-C4, wherein the device graph further |
| | comprises an endpoint object, wherein the endpoint object comprises an |
| | application-side shared buffer and an endpoint-side shared buffer, and wherein the |
| | endpoint object is entirely offloaded to the audio co-processor and does not |
| | include any CPU-based component. |
| C6 | The computer system of any one of C1-C4, wherein the device graph is a first |
| | device graph, wherein the audio pump object is a first audio pump object, and |
| | wherein the audio device graph builder further comprises a second device graph, |
| | the second device graph comprising a second audio pump object executable on the |
| | CPU. |
| C7 | The computer system of any one of C1-C6, wherein the connection buffer is stored |
| | in memory accessible to the audio co-processor, and wherein metadata for the |
| | connection buffer is accessible to the CPU. |
| C8 | The computer system of any one of C1-C7, wherein the device graph further |
| | comprises an audio processor object, and wherein the audio processor object is |
| | configured to include references to the APO and the connection buffer in the |
| | objects store. |
| C9 | The computer system of any one of C1-C8, wherein the device graph further |
| | comprises an audio processor object, wherein the audio processor object is |
| | partially offloaded from the CPU to the audio co-processor, and wherein the APO |
| | and the connection buffer are each partially offloaded from the CPU to the audio |
| | co-processor. |
| C10 | The computer system of any one of C1-C9, wherein the audio endpoint is one of a |
| | plurality of audio endpoints coupled to the computer system, and wherein the |
| | audio device graph builder further comprises an objects store and a device graph |
| | for each of the plurality of audio endpoints. |
| C11 | The computer system of C10, wherein the plurality of audio endpoints comprises |
| | an audio render endpoint and an audio capture endpoint. |

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

We claim:

1. In a computing device comprising a central processing unit (CPU) and an audio co-processor, a method comprising, with the CPU:
receiving a request from an application to add an audio stream to a device graph, the device graph being associated with an audio endpoint;
responsive to receiving the request, modifying the device graph to incorporate the audio stream, including causing the audio co-processor to create a processing pipeline for the audio stream in the device graph, the processing pipeline comprising an audio processing object (APO); and
directing the audio co-processor to process the audio stream with the modified device graph.

2. The method of claim 1, wherein the APO comprises a configuration interface accessible to the CPU and a streaming interface accessible to the audio co-processor, wherein the APO is one of a plurality of APOs, and wherein the processing pipeline comprises the plurality of APOs and a plurality of connection buffers, the APOs being linked together by the connection buffers to form the processing pipeline.

3. The method of claim 2, wherein modifying the device graph to incorporate the audio stream further comprises allocating the connection buffers from memory accessible to the audio co-processor, and wherein metadata for the connection buffers is accessible to the CPU.

4. The method of claim 1, further comprising, responsive to receiving the request, with the CPU:
creating an application-side shared buffer for the audio stream, the application-side shared buffer being accessible to the application and the audio co-processor.

5. The method of claim 1, wherein the audio endpoint is a render audio endpoint, the method further comprising, with the CPU:
receiving a request to add a capture audio stream to a device graph for a capture audio endpoint;
responsive to receiving the request to add the capture audio stream:
creating an endpoint-side shared buffer for the capture audio stream, the endpoint-side shared buffer being accessible to the capture audio endpoint and the audio co-processor; and
modifying the device graph for the capture audio endpoint to incorporate the capture audio stream, including causing the audio co-processor to create a processing pipeline for the capture audio stream in the device graph for the capture audio endpoint; and
directing the audio co-processor to process the capture audio stream with the modified device graph for the capture audio endpoint.

6. The method of claim 1, wherein the audio endpoint is a render audio endpoint and the audio stream is a render audio stream, the method further comprising, with the CPU:
receiving a request to add a loopback stream to the device graph for the render audio endpoint;
responsive to receiving the request to add the loopback stream:
creating an application-side shared buffer for the loopback stream, the application-side shared buffer for the loopback stream being accessible to the render audio endpoint and the audio co-processor; and
modifying the device graph for the render audio endpoint to incorporate the loopback stream, including causing the audio co-processor to create a processing pipeline for the loopback stream in the device graph for the render audio endpoint that branches off from the processing pipeline for the render audio stream; and
directing the audio co-processor to process the loopback stream, along with the render audio stream, with the modified device graph for the render audio endpoint.

7. The method of claim 1, wherein modifying the device graph to incorporate the audio stream further comprises determining a topology of the device graph with a CPU-based component of an audio processor object of the device graph, and wherein the topology comprises a list of APOs and connection buffers in the processing pipeline.

8. One or more non-transitory computer-readable media having stored thereon computer-executable instructions for causing an audio co-processor of a computing device, when programmed thereby, to perform operations comprising:
responsive to a request from an application to add an audio stream to a device graph, with the audio co-processor, creating a processing pipeline for the audio stream in the device graph, the processing pipeline comprising an audio processing object (APO), and the device graph being associated with an audio endpoint; and
processing the audio stream with the device graph by executing an audio pump thread with the audio co-processor.

9. The one or more computer-readable media of claim 8, wherein the computing device further comprises a central processing unit (CPU), wherein processing the audio stream with the device graph by executing the audio pump thread with the audio co-processor comprises reading audio data for the audio stream from a shared buffer accessible to the CPU and the audio co-processor, and wherein the audio data is read from the shared buffer before any processing on the audio data is performed by the CPU.

10. The one or more computer-readable media of claim 8, wherein the audio stream is a render audio stream, and wherein processing the audio stream with the device graph by executing the audio pump thread with the audio co-processor comprises:
receiving a buffer completion signal from a device driver of the audio endpoint;
responsive to receiving the buffer completion signal, initiating execution of the audio pump thread; and
invoking the APO of the processing pipeline for the audio stream.

11. A computer system comprising:
a central processing unit (CPU);
an audio co-processor;
memory accessible to both the CPU and the audio co-processor; and
an audio device graph builder comprising:
an objects store for an audio endpoint, the objects store comprising a connection buffer and an audio processing object (APO), the APO comprising a configuration interface accessible to the CPU and a streaming interface accessible to the audio co-processor; and
a device graph for the audio endpoint, the device graph comprising an audio pump object executable on the audio co-processor.

12. The computer system of claim 11, wherein the audio pump object is configured to provide an execution environment for an audio pump thread, and wherein the audio pump object is entirely offloaded to the audio co-processor and does not include any CPU-based component.

13. The computer system of claim 12, wherein the audio co-processor is configured to perform operations comprising:
responsive to receiving a buffer completion signal from a device driver of the audio endpoint, initiating execution of the audio pump thread; and
during the execution of the audio pump thread, invoking a processing pipeline for an audio stream, the processing pipeline comprising the APO and the connection buffer.

14. The computer system of claim 13, wherein the audio stream is a first audio stream, and wherein the audio co-processor is further configured to perform operations comprising:
during the execution of the audio pump thread, invoking a processing pipeline for a second audio stream and a processing pipeline for a third audio stream.

15. The computer system of claim 11, wherein the device graph is a first device graph, wherein the audio pump object is a first audio pump object, and wherein the audio device graph builder further comprises a second device graph, the second device graph comprising a second audio pump object executable on the CPU.

16. The computer system of claim 11, wherein the connection buffer is stored in memory accessible to the audio co-processor, and wherein metadata for the connection buffer is accessible to the CPU.

17. The computer system of claim 11, wherein the device graph further comprises an audio processor object, and wherein the audio processor object is configured to include references to the APO and the connection buffer in the objects store.

18. The computer system of claim 11, wherein the device graph further comprises an audio processor object, wherein the audio processor object is partially offloaded from the CPU to the audio co-processor, and wherein the APO and the connection buffer are each partially offloaded from the CPU to the audio co-processor.

19. The computer system of claim 11, wherein the audio endpoint is one of a plurality of audio endpoints coupled to the computer system, and wherein the audio device graph builder further comprises an objects store and a device graph for each of the plurality of audio endpoints.

20. The computer system of claim 19, wherein the plurality of audio endpoints comprises an audio render endpoint and an audio capture endpoint.
